(19) United States
(12) Patent Application Publication
(10) Pub. No.: US 2026/0242094 A1
(43) Pub. Date: Aug. 20, 2026

(54) TidySqueeze21

(71) Applicant: Michael John Gordon, Bedford (GB)

(72) Inventor: Michael John Gordon, Bedford (GB)

(21) Appl. No.: 19/154,632

(22) PCT Filed: Feb. 9, 2024
(86) PCT No.: PCT/GB2024/000006

§ 371 Date: Aug. 7, 2025

(30) Foreign Application Priority Data
Feb. 9, 2023 (GB) 2301864.1

(51) Int. Cl. B65D 23/00; A47K 5/122

(52) U.S. Cl. CPC B65D 23/003; A47K 5/122; A47K 2201/02; B65D 2501/0081

(57) ABSTRACT

The invention relates to a support system and dispensing container assembly for liquids, gels or similar.

A support system features a receptacle A which is attached to a connection strip 18, the connection strip 18 being attached to an adhesive devise (a pad 19), the pad being attached to a support structure like a wall. The free standing dispensing container B for gels or liquids can be firmly and releasably held by the receptacle A, the dispensing aperture (not shown) of the dispensing container B facing downwards.

### BRIEF SUMMARY OF INVENTION

The present invention relates to a support member for a dispensing container for liquids or gels like bottles of shampoo, shower gel or even sauce bottles like tomato ketchup.

Various types of dispensing containers for liquids are known such as shampoo bottles, and sauce bottles (e.g. tomato ketchup). Sometimes these dispensing container bottles feature pump or plunger mechanisms. Much of the time these dispensing containers can be left on a shelf or other surface when not in use, but are then picked up manually to use them. This generally requires the user to bend down, pick up the dispenser container bottle, then hold it with one hand while the product is being used and then put the bottle down again. Also these bottles can take up surface space.

There is often not a convenient or secure means to accommodate these containers. For example if a shampoo bottle is placed on a shelf or around the bath tub, it can easily topple over, a bottle of gel attached to a shower cord by a hook mechanism or similar may swing around or fall if accidentally knocked or a sauce bottle may not be secure sitting on a surface in a ship's galley.

### PRIOR ART

Examples of an improved method to enable these bottles to be used without confiscation of space around the tub is described in DE 20 2007 018 022 U1. The bottle features an attachment means located on the side of the bottle which enables the bottle to attach to a support member the latter being attached to a support structure like a wall. A problem with this method is that the bottle requires an external attachment which some would see as being an extra expense or complication in the production process, or one that may detract from the aesthetics of the bottle. In another embodiment of DE 20 2007 018 022 U1, the support member engages with an indent in the bottle itself in order to provide a firm engagement fit. The engagement means is therefore inserted into the cavity of the bottle, rather than the bottle being inserted into the engagement means of the support member. A problem with this method is that the bottle is only stabilised by this single location of engagement which may not be enough to keep the bottle stable during usage.

Another example of an improved method to prevent bottles for gels and liquids from falling that enables a user to extract product without having to hold onto the bottle whilst extracting product from it is described in EP 0 997 384 A1. In order to ensure that the bottle is held firmly within the retaining support member, the bottle features a protrusion/projection which is first inserted into the retaining member, then the locking mechanism on the retaining member is adjusted in order to ensure that the article is locked into the retaining member. Of necessity therefore this is a two part process, one to insert the article into the retaining member, a second to adjust the locking means in order to lock the article within the retaining member. Similarly, when releasing the article from the retaining means, the locking means needs to be adjusted so as to enable the article to be released.

However this mechanism has numerous problems which will restrict its usefulness within a domestic setting. Firstly, it is highly invasive to the support structure. Secondly it is restricted to environments wherein the user has access to both sides of said support structure. It is therefore inappropriate for use within most bathrooms where the support structure comprises the wall of the bathroom or shower cubicle. Thirdly, the protrusion on the bottom of the bottle renders the bottle unstable such that it will not stand freely on a supermarket shelf or the rim of a bath. Fourthly manufacturers of major brands would consider that this protrusion spoils the visual appearance/equity of the bottles.

US 2003/021033 and WO 2004/004529 A1 disclose bottles for use with a support member, or mount, to prevent theft of the bottle. Both US 2003/021033 and WO 2004/004529 A1 disclose assembled systems which secure the container into the mount and allow the container to be rotated without causing disengagement of the container from its mount.

These systems are primarily designed to enable the bottle to be rotated within its mount to a proper orientation for the user. In order to secure the bottle within its mount, the body of the mount or its constituent components or its means of attachment to the support structure is invasive to the support structure. Within a domestic dwelling, this invasiveness may cause unacceptable damage to the paintwork or tiling of the support structure, and removal of the mounting may leave unsightly damage to it that will require attention. The non dispensing end of the bottle features a protrusion which could render the bottle unable to stand on its non dispensing end on a supermarket shelf or on a domestic bathroom surface.

The protrusion would also be viewed by brand managers as being unsightly.

Research undertaken involving the manufacturers of key shampoo, conditioner and shower gel brands reveals that any engagement mechanism applied to their bottles of product must not alter their overall appearance as they appear on the supermarket shelf to the purchaser. This is because very often the manufacturers of these branded body wash products spend considerable amounts of time, effort and money on developing the ‘personality’ of the their design, their ‘visual equity’, and they would not be prepared to compromise the shape or design of the bottles to such a major degree in order to enable the bottles to become securely engaged within their support members.

Support members already exist which are non-invasive to the host support structures. U.S. Pat. No. 5,439,193A discloses a container inverting support which attaches to a vertical surface by means of suction pads. It supports the bottle by the neck or the portion of the container adjacent its opening. This means that the container is supported at its slimmest and thereby weakest location, along the neck, which could make it unstable. It would be more advantageous to support the container at a portion of the container with a more substantial diameter rather than the neck or the area immediately adjacent the opening of the container.

DE20227018022 discloses a container inverting support which attaches to a vertical surface. A support unit is fastened to the support structure and the bottle attaches to the support unit by means of an attachment means located at the back of the bottle. The problem with this mechanism is that support for the bottle is only provided at one location, its back. No extra stability and support is provided for the front or sides of the bottle.

GB2467816 also discloses another support system which supports a dispensing container in an inverted position which attaches to a vertical surface. The dispensing container is in the form of a ‘squeeze-to-use’ bottle for shampoo or other gels or liquids. It is held within a receiving devise, the part of a support system which engages with and supports the bottle. The receiving devise is in the form of a receptacle which holds a section of the body of the bottle located towards its non-dispensing end, which has a more substantial diameter and more robust structure than the neck of the bottle. This provides for greater stability when the bottle is being inserted and removed through the side opening of the receptacle section and ensures for a more robust engagement between the support member and the bottle thereby providing greater stability for when the user squeezes product from the bottle.

The receptacle featured in GB2467816 provides support for the bottle at its back, front and sides. However, insertion of the bottle into or removal of the bottle from the support exerts rotational forces in the horizontal plane which could result in the support system becoming detached from the vertical support structure. Similarly, once installed within the dispenser, as the user opens the cap of the bottle or squeezes product from it, the tendency is there to inadvertently either push the bottle towards or pull it away from the support structure. These rotational forces acting in the vertical plane could also result in the support member becoming detached from the vertical support structure.

It would therefore be preferable to ensure that the engagement method between the bottle and the support minimises the risk that any such rotational forces exerted in either the horizontal or vertical planes could result in detachment of the bottle support system from the vertical support structure.

The invention seeks to provide a solution to these problems and can apply for either squeeze-to-use bottles or bottles made from a more rigid, inflexible material.

### BRIEF SUMMARY OF THE INVENTION

According to the present invention there is provided a support system and dispensing container assembly for gels or liquids comprising:
a) a dispensing container for gels or liquids, being fully sealed and self contained, which can be connected to and released from a receiving device of the support system, the dispensing container featuring a dispensing aperture at one first end to enable gel or liquid to be dispensed, and wherein the body of the dispensing container has a body which includes at least one engagement component,
b) a support system comprising:
   an adhesion device that adheres to a support structure,
   a receiving device configured to releasably engage the dispensing container,
   a moveable connection strip with first and second ends which attaches to the adhesion device at one of its ends and to the receiving device at the other end,
      wherein the receiving device comprises a back plate which bears at least one engagement component which correspond to the at least one engagement component upon the dispensing container body.

Preferably at least one engagement component of the receiving device is located directly upon a planar surface of the back plate.

Preferably at least one engagement component of the receiving device is located upon at least one side structure of the back plate.

Preferably both the body of the dispensing container and the receiving device each play host to separate corresponding engagement components of an engagement mechanism which cooperate in order to form a firm connection to releasably hold the dispensing container after the dispensing container has been engaged with the receiving device.

Preferably the receiving device features an opening which is non parallel to its circumferential structure and runs the full width of the receiving device through which a section of the body of a dispensing container can be inserted.

Preferably the body of the dispensing container can be inserted into the receiving device sideways on.

Preferably the receiving device features at least one side section to support the dispensing container.

Preferably at least one of the side sections of the receiving device features a front section to support the dispensing container.

Preferably the inside of at least the front or side sections of the receiving device features some form of gripping means.

Preferably the first end of the dispensing container faces downwards after insertion of the dispensing container into the receiving device.

Preferably the engagement mechanism that comprises a first engagement component located away from the first end and towards the second end of the dispensing container which releasibly interlocks with a second engagement component on the receiving device.

Preferably the engagement mechanism comprised of two components, wherein at least one of the engagement components to be found on either the dispensing container or the receiving device is at least in part a raised structure which engages with a second engagement component which is at least in part an indented structure, the second component being located on the respective receiving device or dispensing container to which the receiving device or dispensing container engages in order to form a firm, releasable connection,

Preferably the engagement mechanism comprising a first engagement component on the dispensing container which inserts into the second engagement component on the receiving device.

Preferably the receiving device with a second engagement component selected from a group comprising a ridge or ridges, a notch or notches or other indented structure which engages with a first engagement component selected from a group comprising pips, protrusion or other raised structure on the dispensing container to form a firm, releasable connection.

Preferably the engagement mechanism comprising a second engagement component on the receiving device which inserts into the first engagement component on the dispensing container.

Preferably the engagement mechanism comprising a first engagement component on the receiving device which inserts into the second engagement component on the dispensing container.

Preferably the second engagement component is located on the inside circumference of the receiving device.

Preferably the receiving device is essentially a single piece structure.

Preferably engagement of the dispensing container with the receiving device and subsequent release of the dispensing container from the receiving device is performed by holding and manipulating the dispensing container relative to the receiving device.

Preferably the engagement mechanism between the receiving device and the dispensing container is consummated by securely holding the receiving device with one hand and then rotating the dispensing container in a first direction relative to the receiving device wherein a firm releasable engagement is formed between the receiving device and the dispensing container.

Preferably the engagement mechanism between the receiving device and the dispensing container is released by securely holding the receiving device with one hand and then rotating the dispensing container relative to the receiving device in a direction opposite to the first direction to a second position wherein the dispensing container and the receiving device are fully unlocked from each other and the container is fully released from the receiving device.

Preferably the engagement mechanism between the first and second components is consummated by securely holding the receiving device with one hand and then rotating the dispensing container in a first direction relative to the receiving device featuring the second component to a first position wherein the first and second components are fully interlocked with each other and the container cannot rotate any further in the first direction.

Preferably the engagement mechanism between the first and second components is released by rotating the dispensing container relative to the receiving device in a direction opposite to the first direction to a second position wherein the first and second components are fully unlocked from each other and the container is fully released from the receiving device

Preferably at least engagement or disengagement between the dispensing container and the receiving device can be consummated with a single rotating action.

Preferably the dispensing container which has a surface contact means at the first end of the dispensing container opposing the second end allowing the dispensing container to freely stand on a surface on the surface contact means.

Preferably the dispensing container with a surface contact means at a second end of the dispensing container opposing the first end allowing the dispensing container to stand on a surface on the surface contact means.

Preferably the engagement mechanism predetermines the orientation of the dispensing container relative to the support system.

Preferably the dispensing container is squeeze-to-use.

Preferably the support system is attached to the support structure and when the receiving device is in its resting position, an outside section of the receiving device essentially lies flat against the support structure.

Preferably the support system attaches to the support structure in a manner which is non-invasive to the support structure comprising a method selected from the group consisting chemical adhesive surface, suction pads, suction cups, bio-mimicry technology or other non-invasive method.

Preferably the receiving device features an upper support plate.

Preferably the connection strip is made from a flexible material.

Preferably the second engagement component features ends which are arrowhead or any other bulbous shape to provide extra resistance to dispensing container extraction from the receiving device.

Preferably the dispensing container is in a vertical position being engaged within the receiving device prior to use, the dispensing container lies almost flat against the vertical support structure.

Preferably the pre-moulded indent or indents are located on any section or sections between the shoulders and the base of the dispensing container which does not spoil the visual equity of the dispensing container, its frontal appearance.

Preferably the engagement component or components on the dispensing container are pre-moulded.

### DETAILED DESCRIPTION OF THE INVENTION

Embodiments of the invention will now be described with reference to the accompanying drawing in which:

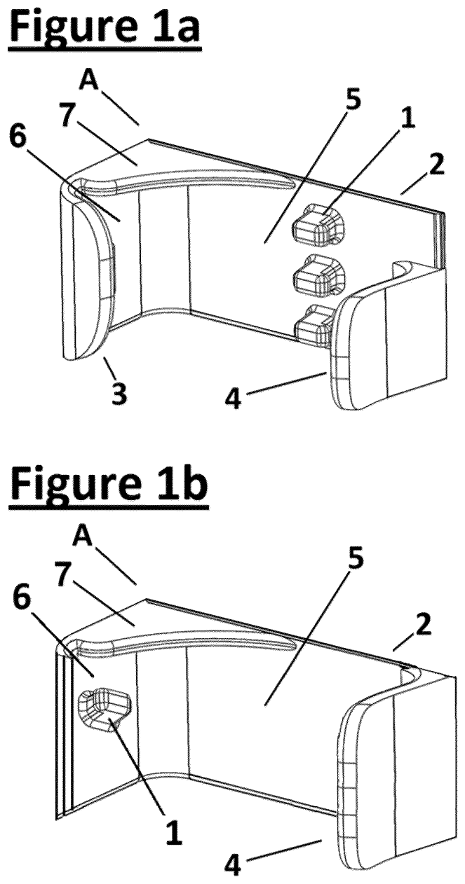

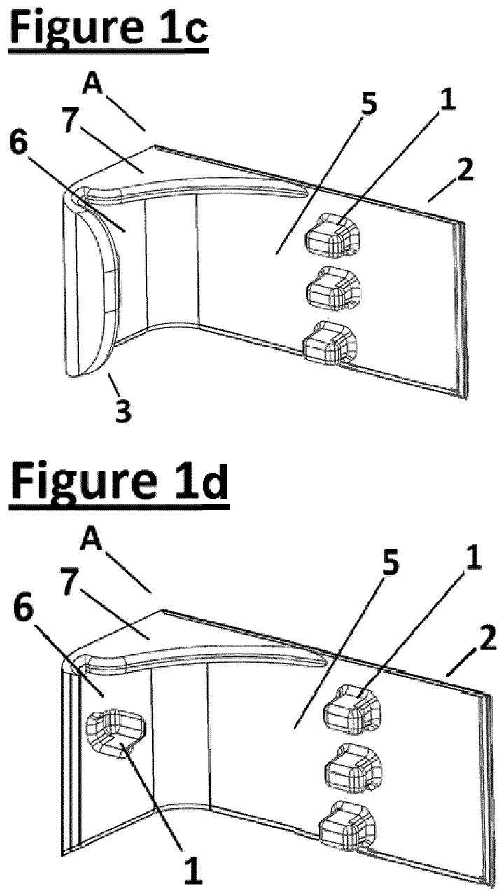

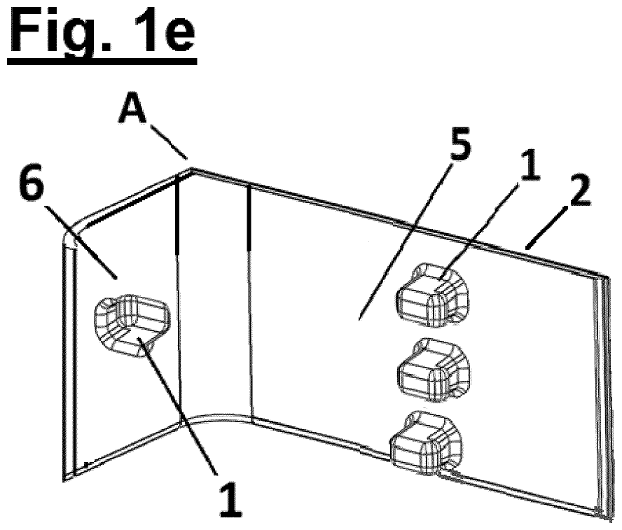

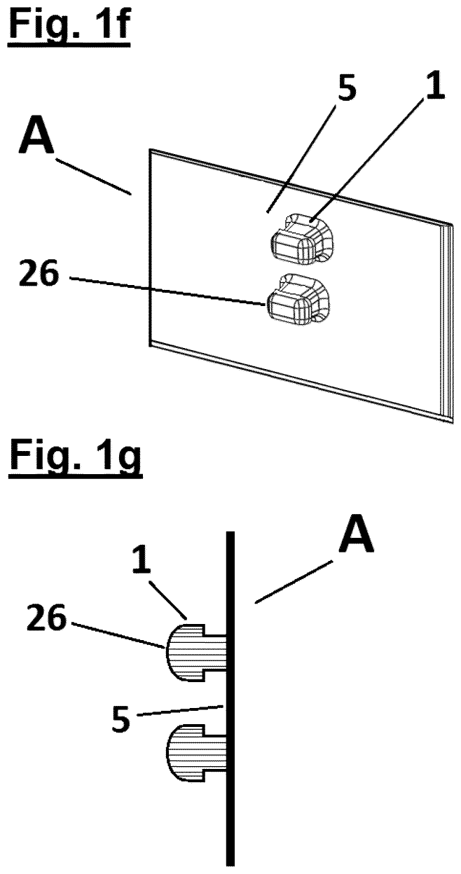

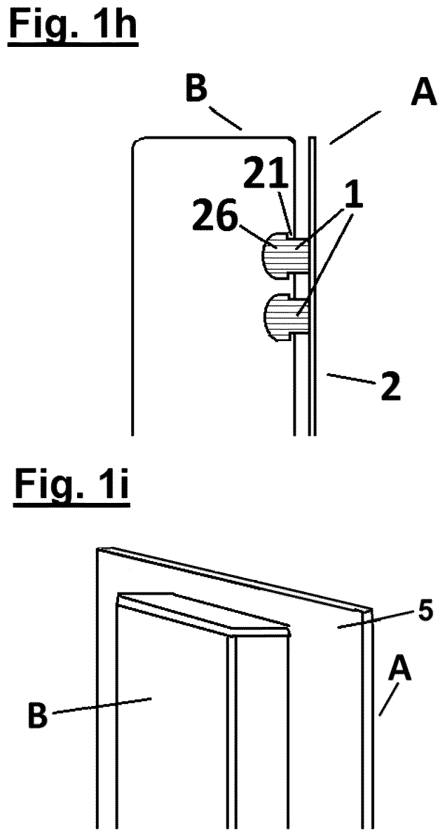

FIGS. 1a, 1b, 1c, 1d, 1e, 1f, 1g, 1h, 1i show generally frontal views of a receiving device in the form of a receptacle. The receptacle is designed to receive a dispensing container which could perhaps be a bottle of shampoo, conditioner, shower gel, body lotion or bottle/dispensing container of some other type of essentially liquid or gel contents.

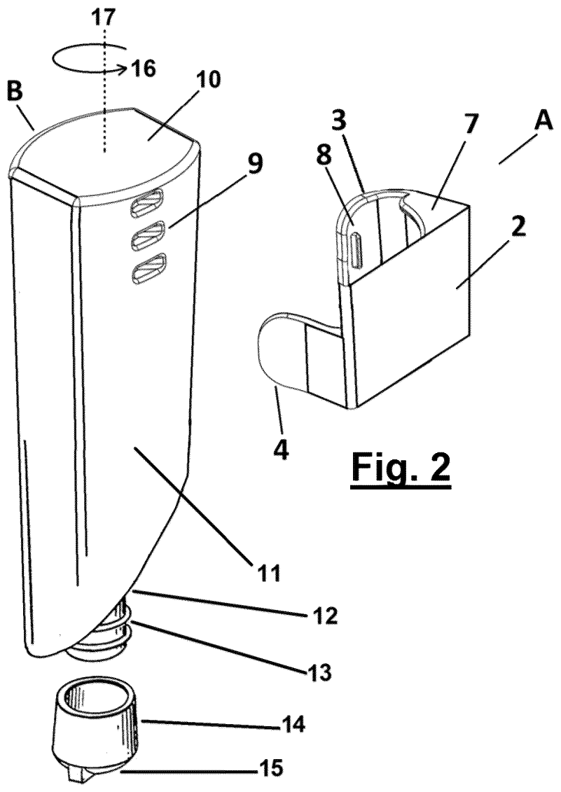

FIG. 2 shows a generally side on, rear view of a dispensing container bottle and a rear view of a receptacle.

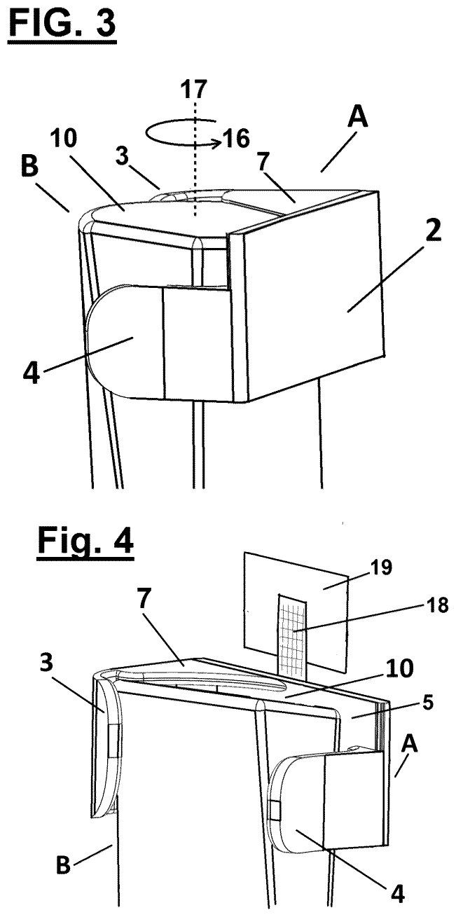

FIG. 3 shows a generally rear view of the non dispensing end of said dispensing container, a bottle, engaged within a receptacle.

FIG. 4 shows a generally frontal view of the non dispensing end of a bottle engaged within a receptacle. A connection strip connects the receptacle to an adhesion devise, the adhesion devise being in the form of a pad which is connected to a vertical support structure.

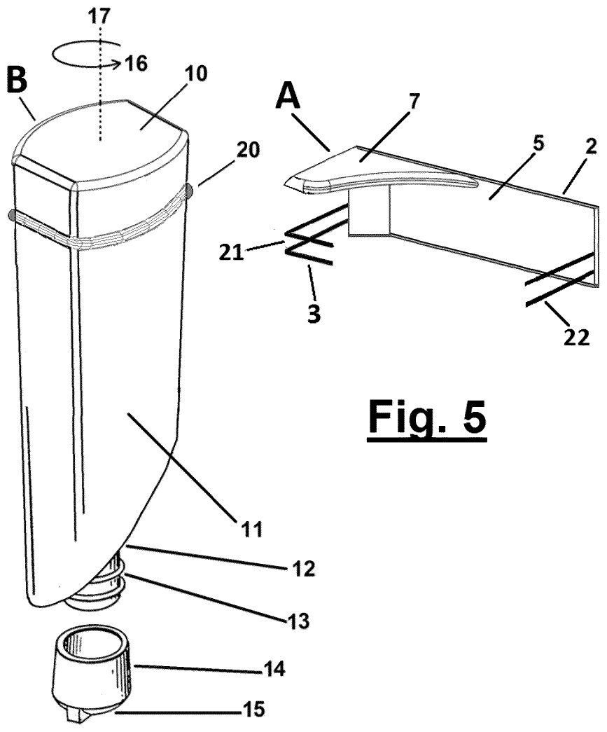

FIG. 5 shows a generally side-on, rear view of a bottle and a generally frontal view of a receptacle.

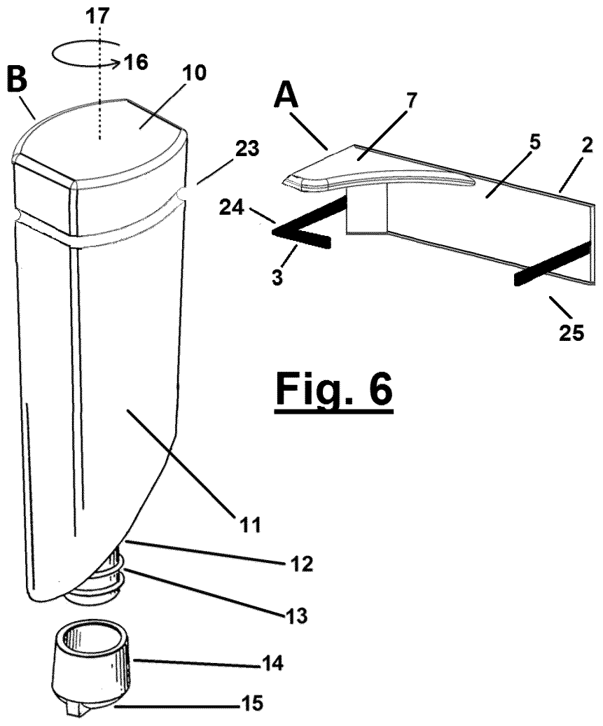

FIG. 6 shows a generally side-on, rear view of a bottle and a generally frontal view of a receptacle.

Referring to FIG. 1a there is shown a receptacle A. The receptacle A is in a horizontal position. It features two resilient side sections and a defining slit opening which is non parallel to its circumferential structure which is defined by the front section 3 and the side section 4. This slit opening enables a section of the body of a bottle (not shown) to be inserted sideways on into it. The ends of 3 and 4 flare outwards away from the body of the receptacle in order to facilitate insertion of said bottle. The inside back plate 5 on the inside of the receptacle A features three protrusions 1, which are raised sections which noticeably protrude from the inside surface of the receptacle A. When engaged with the indents on the bottle, these protrusions 1 help support the bottle after its insertion into the receptacle A.

The inside surface of the front section 3 engages with a section on the front of said bottle. To guide the user to insert said bottle correctly so as to ensure engagement between the indents on the bottle with the protrusions 1 on the inside of the receptacle A and then ensure that the back of the bottle the bottle lies flush with the inside back plate 5 of the receptacle A, the user inserts the non dispensing end of the bottle into the receptacle such that the base of the bottle comes into contact with the upper support plate 7.

Referring to FIG. 1b there is shown a receptacle A. The receptacle A is in a horizontal position and features two side sections 4 & 6. The end of side section 4 flares outwards away from the body of the receptacle in order to facilitate insertion of said bottle. The internal surface of the side plate 6 features a protrusion 1 which noticeably protrudes from the inside surface of the receptacle A. When a bottle (not shown) is inserted sideways on through the defining opening between the side sections 4 & 6, the protrusion 1 becomes engaged with the indent on said bottle, the protrusion 1 helps support the bottle after its insertion into the receptacle A. After the indent on the bottle has become engaged with the protrusion 1 and the back of the bottle lies flush with the inside back plate 5 of the receptacle A, the upper support plate 7 can stay in contact with the surface of the non dispensing end of the bottle to provide still further support for the bottle by countering any clockwise rotational forces in the vertical plane.

Referring to both FIGS. 1a & 1b, the protrusions 1 feature a flat upper surface. However the protrusions 1 could be any other shape that provides for firm engagement. For example they could be conical in shape so that the corresponding indents on the bottles can be as innocuous as possible. Alternatively, in order to resist downward pressures on the bottle which could result in the protrusions 1 becoming disengaged from the indents on the bottle, the upper surfaces could each be horizontal or upward facing or the inside back plate 5 could instead feature protrusions each of which has either conical, horizontal or upward facing surfaces. There could be a single or multiple protrusions 1 which could be arranged in vertical, horizontal or an irregular formation on the inside back plate 5 or the side sections 4 & 6 or anywhere on the inside surface of the receptacle A.

Referring to FIG. 1c there is shown a receptacle A. The receptacle A is in a horizontal position and features one side sections 6 and a front section 3. The internal surface 5 of the receptacle A features protrusions 1. When a bottle (not shown) is inserted sideways on through the defining opening between the side section 6 and the protrusions 1, the protrusion 1 becomes engaged with the indent on said bottle, the protrusions 1 help support the bottle after its insertion into the receptacle A. Again after the indents on the bottle have become engaged with the protrusions 1 and the back of the bottle lies flush with the inside back plate 5 of the receptacle A, the upper support plate 7 can stay in contact with the surface of the non dispensing end of the bottle to provide still further support for the bottle by countering any clockwise rotational forces in the vertical plane.

Referring to FIG. 1d there is shown a receptacle A. The receptacle A is in a horizontal position and features one side section 6 with a top section but without any front section.

Referring to FIG. 1e there is shown a receptacle A. The receptacle A is in a horizontal position and features one side section 6 without any front section and without a top section. The internal surfaces 5 and 6 of the receptacle A feature protrusions 1. When a bottle (not shown) is inserted sideways on through the defining opening between the side section 6 and the protrusions 1, the protrusion 1 becomes engaged with the indent on said bottle, the protrusions 1 help support the bottle after its insertion into the receptacle A.

Referring to FIG. 1f there is shown a receptacle in the form of a support devise A, the support devise A is in a vertical position. It features two protrusions 1 attached to a back plate 5. Each of the protrusions 1 feature bulbous ends 22 which insert into indents on the back of a bottle (not shown). The bulbous ends provide extra resistance to detachment of said bottle from the receptacle. When engaged with the indents on said bottle, the dispensing end of the bottle will face downwards.

Referring to FIG. 1g there is shown a side view of a cross section of a support devise A in a vertical position. The support devise A features two protrusions 1 which engage with a bottle (not shown) when the ends of the protrusions are inserted within the indents of said bottle.

Referring to FIGS. 1h and 1i, there is shown two perspectives of the non dispensing end of the bottle B after the protrusions 1 with bulbous ends on the support devise A have engaged with the indents on the bottle B. Referring to FIG. 1h, the bottle B features indents which can accommodate protrusions on the support devise A, the support devise A being essentially of flat design. The lip 21 ensures a firm engagement fit between the bulbous end 22 of the protrusion 1 and the bottle. By applying enough force, the flexible nature of the material that comprises the bottle enables the user to overcome the resistance of the lip 21 of the bulbous end 22 and to thereby insert the bulbous ends 22 of the protrusions 1 into the pre-moulded indents (not shown) on the bottle. When enough reverse force is applied to the bottle in order to overcome the resistance of the lip 21 of the bulbous end 22, disengagement of the bottle from the support devise is enabled.

Alternatively the essentially flat resilient support devise A could feature the indents into which protrusions located on the bottle can be accommodated.

Referring to FIG. 1i, there is shown a generally side on, front view of the non dispensing end of the bottle B after its engagement onto the receptacle A. The protrusions (not shown) on the back plate 5 of the receptacle A now protrude into the pre-moulded indents (not shown) of the bottle B enabling the bottle B to lie flush along the back plate 5. It could be that the bottle features said protrusions and the receptacle features said indents, the engagement mechanism being essentially of the same principle.

Referring to FIGS. 1a, 1b, 1c, 1d, 1e, 1f, 1g, 1h and 1i, the side plates 6 and back plates 5 could feature any number of protrusions or indents. And in order to improve the firmness of engagement between the protrusions 1 and the indents on the mentioned bottle, some or all of the protrusions 1 could feature bulbous or arrowhead shaped ends 22, which insert into correspondingly shaped indents on the back of said bottle. Once the bottle is engaged with the receptacle A, the outside back plate 2 can be allowed to lie flat against the support structure (not shown).

Additionally, the receptacle A referred to in FIGS. 1a, 1b, 1c, 1d, 1e, 1f, 1g, 1h and 1i could comprise a single piece structure and does not require any moving parts like clamps, hinges, rollers, clips etc in order for firm engagement between the container B and the receptacle A to be consummated. Therefore the receptacle A can be made from a single material using a single shot moulding tool with no extra assembly costs. This thereby makes the receptacle easier, less complicated and generally cheaper to produce than a receptacle comprising a multiplicity of parts that requires a final assembly process.

Referring to FIG. 2, there is shown a generally side on, rear view of the non dispensing end of the bottle B and the receptacle A. The bottle could be squeeze-to-use or feature a dispense pump mechanism perhaps, the bottle being made from a more rigid material that does not lend itself to ‘squeeze-to-use’ dispense operation. The bottle B comprises a main body 11 (defined as the section between the shoulders 12 and the base 10), the shoulders 12 upon which sits a neck 13 and a cap 14 which is secured to the neck 13 of the bottle B. The dispensing aperture (not shown) is covered by the lid 15 of the cap 14. The bottle B features a first component comprising three pre-moulded indents 9 on the reverse side of the body of the bottle to accommodate the protrusions (not shown) on the inside back plate 5 of the receptacle A after the bottle B has been inserted into the receptacle A. There could be a single or numerous indents, each could be conical or any other shape and be in any formation that corresponds to the shape and formation of said protrusions to enable firm engagement between them after insertion of the bottle into the receptacle A. The pre-moulded indents are on the rear of the bottle B but could be located on any section of the body of the bottle between the shoulders and the base of the bottle and will preferably be as subtle and innocuous as possible so as not to spoil the visual equity of the bottle, its frontal appearance, when on a supermarket shelf.

Alternatively in place of the indents, to keep the bottle B stable within the structure of the receptacle A, the bottle B could feature a ridge or series of ridges or any other type of first component which correctly engages with suitably shaped second components on the inside of the receptacle A so as to enable the user to slide the bottle B into the receptacle A, rather than having to rotate it into position.

As shown, the base 10 of the non dispensing end of the bottle B is of a largely oblong/oval shape such that the front and back of the bottle B are wider than its sides. The base is also largely horizontally planar to the vertical axis of the bottle so as to enable the bottle to stand freely on its base. A first component in the form of a protrusion to the base 10 of the bottle B could encumber its standing stability.

In order to insert the bottle B sideways on through the slit opening defined by the front section 3 and side section 4 and into the receptacle A, it will be required that the user grasps the receptacle A with one hand and then manoeuvres the bottle B through the slit opening with the other hand such that the back of the bottle B featuring the indents 9 is at an acute angle to the inside back plate of the receptacle A. Once the bottle B has been inserted at an angle through the slit opening of the receptacle A and the base 10 of the bottle B has been aligned beneath the upper support plate 7, if the receptacle A is made from a resilient material like acrylic which enables some measure of flex depending on its thickness, as the user rotates the bottle in an anticlockwise direction 16 about its axis 17, either the front section 3 of the receptacle A or the side section 4 or both sections flex outwards. Further rotation of the bottle B then results in engagement being consummated between the indents 9 and the protrusions on the inside of the receptacle A, the back of the bottle B lying flush with the inside back plate of the receptacle A. Once engagement between the first and second components has been consummated, the front section 3, side section 4 or both sections of the receptacle A will then flex back again towards their original position of bias and the receptacle predominantly returning to its original shape prior to insertion of the bottle B. The front section 3, side section 4 or both sections thereby provide support to keep the bottle B engaged within the receptacle A.

In order to remove the bottle B from the receptacle A the user would grasp the receptacle A with one hand and the bottle B with the other. Then by rotating the bottle B in the opposite direction about its axis 17, the first and second components can become disengaged and either the front section 3, side section 4 or both sections of the receptacle A then flex outwards as necessary in order to facilitate disengagement between the first and second components so that the bottle B can be removed from the receptacle A with less resistance. Once the bottle B has been removed, the front section 3, side section 4 or both sections of the receptacle A will then flex back again to their original bias positions. The slit opening through which the bottle B is inserted into and removed from the receptacle A could be such that the bottle B needs to be inserted at an orientation more parallel to, rather than acute to, the inside back plate 5 of the receptacle A.

The inside surface of the front section 3 of the receptacle A features a gripping means 8 to provide some measure of frictional support for the bottle B after it has been inserted. This gripping means could be in the form of a protrusion or protrusions, a roughened area or any other form or means to apply frictional forces to the front section of the bottle B in order to provide it with increased stability after insertion. The external back plate 2 is essentially flat so as to ensure that the maximum surface area of the external back plate 2 is in contact with the vertical surface structure (not shown) in order to provide stability for the bottle B after it is inserted within the receptacle A.

The presence of the upper support plate 7 could provide guidance to the user as to how to correctly position the bottle prior to its insertion into the receptacle. Additionally after insertion of said bottle into the receptacle A, the flat surface 10 of the non dispensing end of the bottle B, its surface contact means, can lie essentially flush with the underside of said support plate 7 thereby providing stability against clockwise movement of the bottle B in the vertical plane.

Referring to FIG. 3, there is shown a generally side on view of the non dispensing end of the bottle B after it has been inserted anti clockwise 16 sideways on about its axis 17 into the receptacle A, the dispensing aperture (not shown) of the bottle B facing downwards. The side section 4 of the receptacle A is shown to provide support for the bottle B. The front section 3 is shown to provide support for the front of the bottle B. Part of the surface 10 of the non dispensing end of the bottle B is in contact with the underside of the support plate 7 thereby providing more support for the bottle B as described previously. It could be that the design and construction of the support is such that the bottle needs to be inserted clockwise about its axis 17 into the receptacle A. In either case, being essentially of rigid or semi rigid resilient structure, the shape of the receptacle A remains predominantly similar after the body of the bottle has been inserted into the receptacle A as compared to its shape prior to insertion of said bottle. This means that as the body of the bottle is inserted into the receptacle, either the front section 3, the side section 4 or perhaps both sections may or may not flex in order to accommodate the bottle as it is inserted into the receptacle, receptacle A. It further means that in order to support the bottle within the structure of the receptacle A, perhaps either the front section 3, the side section 4, both sections or perhaps neither section may remain in a flexed position. Even though the front section 3 and or side section 4 are at different angles after insertion of the bottle into the structure of the receptacle compared to their angles prior to insertion, however the shape of the receptacle will essentially be predominantly similar to its shape prior to insertion of said bottle irrespective of the shape of the bottle.

In order for bottles of different circumferential shape to be compatible with the same receptacle, the shape of the first components on these different circumferentially shaped bottles may need to be a little different. For example, a circumferentially wider bottle may require deeper or wider indents in order to consummate a better engagement with the protrusive second component on the inside of the receptacle in order for the bottle to be accommodated firmly and comprehensively within the receptacle.

So by varying the depth and shape of the indents on the bottles, bottles of differing widths can still be enabled to engage with the protrusions on the bottles to ensure firm engagement. Therefore the shape of the receptacle will essentially be predominantly similar to its shape prior to insertion of said bottles irrespective of their circumferential widths or shapes.

Alternatively, the receptacle could be composed of a much more rigid material or design which allows either or the front section or side section 4 to flex very little, instead relying more on the flexible properties of the bottle for it to be able to be inserted into and then become firmly engaged within the receptacle.

So to summarise, the enclosed discloses a system whereby different circumferentially shaped bottles can be accommodated by exactly the same shaped receptacles with the same shape and size of protrusions, the shape of the receptacles remaining predominantly similar prior to and after insertion of said bottles, irrespective of their circumferential shapes.

CN204931515 also discloses a system for supporting bottles of different circumferential shapes featuring a wall attachment unit with a movable strip that connects to a receptacle at its other end. However the receiving devise receptacle disclosed in CN204931515 is made from an elastomeric material, not a resilient material as per the receptacle disclosed herein. After the bottle has been inserted into the CN204931515 receptacle, the two concentric holding structures joined together by a strip, which are made from a less resilient elastomeric material, tighten around the shape of the bottles in order for them to be held firmly within the receptacle. The receptacle is therefore specifically designed to be able to change shape in order to accommodate bottles of different circumferential shapes. Therefore the latter receptacle could be essentially ovular in shape after insertion of a circumferentially ovular shaped bottle and then could be of a more distinctly rounded shape after insertion of a more circumferentially rounded shaped bottle. Therefore the receptacle disclosed in CN204931515 is not of a predominantly similar shape prior to and after insertion of the bottles irrespective of their circumferential shape. Instead the mechanism actually requires that the receptacle can, by design, change in shape as it tightens around the bottles of various widths in order to ensure firm engagement between the bottles and the receptacle. These changes could be quite noticeable depending on the circumferential shape of the bottles.

So to summarise, CN204931515 discloses a system whereby bottles of different circumferential width can firmly engage within exactly the same receptacle. But CN204931515 relies entirely on the possibility that the complete structure of the elastomeric concentric rings that comprises the receptacle can expand in size and shape, perhaps noticeably, in order to accommodate the circumference of a section of the body of bottles of possibly different circumferential size and shape.

Additionally the bottles are typically inserted into the concentric rings of the receptacle disclosed in CN204931515 lengthways and typically engagement is between the receptacle and the dispensing end of the bottle, its first end.

The mechanism employed within this disclosure also enables the bottles to be engaged with the receptacles, however the shape of the receptacle always remaining predominantly the same after insertion of said bottles irrespective of their circumferential size or shape. Additionally engagement generally takes place between the receptacles and a section of the bottles away from their first end and the bottles are essentially inserted into the receptacles sideways on.

It should be noted that if the receptacle disclosed within CN204931515 were to feature a defining opening or slit or be of an open design structure like those shown in FIG. 1a-1i, it simply would not work because it would not be able to tighten around the circumference of the bottle.

Similarly having the receptacle described herein made from the type of elastomeric material so integral to the mechanism employed by the mechanism disclosed within CN204931515 would almost prevent the components from forming the required firm engagement between receptacle and the bottle. Being constructed of generally stiff, resilient materials, the only very limited flex that is apparent as to the receptacle disclosed herein is to be found at the front section 3 and side sections 4 & 6. Firm engagement between the first component on the bottle and a compatible second component on the receptacle is therefore not compromised.

As mentioned herein disclosed, bottles of different circumferential size will fit into the same shaped receptacles by crucially altering the dimensions of the engagement components on the bottles, the receptacles or perhaps both.

Should either of the components described herein be absent or incompatible to each other, firm engagement between the receptacle and the bottle will not be possible.

Therefore for all of these reasons, the principles by which the receptacles within this disclosure and that of CN204931515 accommodate and firmly engage the bottles within the structure of their receptacles are completely different.

Referring to FIG. 4, there is shown a generally side on, front view of the non dispensing end of the bottle B after its insertion into the receptacle A. The protrusions (not shown) on the inside back plate 5 of the receptacle A now protrude into the pre-moulded indents (not shown) of the bottle B enabling the bottle B to lie flush along the inside back plate 5. Again, the receptacle features an upper plate 7. Though not an essential part of the construct of the receptacle, if present it can provide support for the surface 10 of the non dispensing end of the bottle B which could be helpful whilst the bottle B is being inserted or during use. Plate 7 could be a separate piece which is added separately to the structure of the receptacle. The front section 3 can be seen to provide support for the front of the bottle B, the side section 4 of the receptacle A providing support for the side of the bottle B. The receptacle A is of resilient construction such that its shape remains essentially the same after the body of the bottle B has been inserted into it as it was prior to insertion of the bottle B. The receptacle A may be made in whole or part from an inflexible or semi inflexible resilient material.

The adhesion devise connected to the vertical support structure (not shown) is in the form of a pad 19. One end of the connection strip 18 is connected to the back of the receptacle A the other end being connected to the pad 19. The connection strip 18 can be a strong, non-elastic connector that is capable of withstanding tension. The pad 19 could be a section or extension of the strip 18 which features an adhesive or other means for attachment to the support structure.

The pad 19 could be attached to the support structure by an invasive means like a strong high performance chemical adhesive, screws fit or similar. Alternatively the pad 19 could be attached to the support structure by a non-invasive means comprising a method selected from the group consisting chemical adhesive surface, suction pads, suction cups or perhaps a biomimicry, non-invasive technology based on the means by which a Gecko attaches to a vertical surface like Geckskin, or a nano-suction based material like NanoStick or other biomimicry, non-invasive method.

The connection strip 18 is movable meaning that it can enable the user to hold the receptacle A or the bottle B when it is fixed within the receptacle A and lift them away from the support structure without the support system detaching from the support structure.

Therefore the section of the support system that provides adhesion with the vertical support structure, the pad 19, is wholly separated from the receptacle A by this connection strip.

By contrast disclosure GB2467816 describes a support member which has to be of firm rigid unitary structure in order to deliver two of its disclosed essential benefits.

First essential benefit: Access to the full circumference of the bottle. In order to enable ‘access to the full circumference of the bottle’ when it is fixed within the receptacle so that product can be squeezed from it, disclosure GB2467816 relies entirely on the receptacle being in an immovable, fixed position, there being a permanently fixed gap between the receptacle and the back plate/vertical support structure.

The presence of this gap however means that whilst squeezing product from a bottle fixed within the receptacle GB2467816, the user could easily inadvertently pull the end of bottle outwards from the support structure or push the bottle inwards towards the support structure. The resultant rotational forces exerted on the bottle and support system in vertical plane could thereby result in detachment of the bottle from the receptacle or detachment of the complete support member shown in GB2467816 from the support structure.

Additionally the presence of said gap means that the receptacle protrudes from the surface of the support structure making it easier for some-one to inadvertently knock into the bottle and the receptacle of the support system. The resultant rotational forces exerted on the bottle and support system in either the horizontal or vertical plane from such a collision could thereby result in detachment of the bottle from the receptacle or detachment of the complete support member shown in GB2467816 from the support structure.

However as shown in FIG. 4 disclosed within, when the bottle B is engaged within the receptacle A of the support system and prior to its use, the bottle B essentially lies almost flat against the vertical support structure (not shown), for example a bathroom wall, making it less obtrusive, thereby reducing the likelihood for accidental impact.

Additionally even if accidental impact does occur whilst the receptacle is in its resting position against the wall, the wall or the movable connection strip will therefore absorb much of the impact of any forces applied to the front of the bottle B in the horizontal plane.

Within this disclosure, in order to gain access to the full circumference of the bottle in order to open the cap of the bottle and extract product from it, the user is compelled to lift the bottle B away from the support structure and to hold the bottle B firmly with one hand whilst removing the cap that covers the aperture or whilst squeezing product from bottle B into the other hand. The receptacle must therefore be movable.

This is accomplished by having the movable connection strip 18 which makes it necessary for the user to use both hands when inserting or removing the bottle to or from the receptacle or when dispensing product from said container. Being a voluntary necessary and thereby controlled action, this will therefore be much less likely to cause the support system to detach from the support structure.

The enclosed disclosure therefore requires a completely different means and method to that declared in the GB2467816 disclosure to enable the user to gain access to the full circumference of the bottle when said bottle is firmly engaged within the receptacle.

Second essential benefit: Enabling the user to insert the bottle into and to remove it from the receptacle with a single hand without supporting the support member with the other.

The support member disclosed within GB2467816 needs to be of a firm rigid unitary structure so as to provide this very specific item of utility, as highlighted on Page 3, paragraph 3 in the GB 2467816 description document, that of enabling the user to insert the bottle into and to remove it from the receptacle with a single hand. Without the complete structure of the support member being rigid, the receptacle would not be able to resist the rotational forces exerted when the bottle is inserted into and removed from it.

Inclusion of a movable connection strip to the structure of the support system disclosed within GB2467816 would not be obvious to the skilled person because it would compromise its unitary structure and no longer provide the support system with the required resistance to enable the user to insert the bottle into and to remove it from the receptacle with a single hand.

In order to counter the weight of the dispensing container and thereby provide extra stability for it, the support devise could feature protrusions set at an angle that is upward facing relative to the support structure to which it is attached. The dispensing container would therefore feature an indent set at a similar angle to the angle of the protrusions in order to ensure compatibility and a firm engagement between the upward facing protrusions and the indents.

Referring to FIGS. 5 and 6, either just the body of the bottle or just the receptacle play host to a component which forms the basis of an engagement mechanism. It is a single component that enables firm and releasable engagement between the bottle and the receptacle. The receptacles in each case would be attached to a connection strip (not shown), which attaches to an adhesion devise (not shown) that connects to the vertical support structure (not shown).

So rather than comprising the interconnection between a pre-moulded component on the bottle and a second pre-moulded component on the receptacle, the engagement mechanism instead comprises a component on the bottle only which engages with the two side sections of the receptacle, the receptacle itself not featuring a distinct second component built into the sides of the receptacle per se. as those identified in FIGS. 1a-1i.

Referring to FIG. 5, there is shown the main body of the bottle 11 which plays host to a component 20 in the form of a protrusion which could be partially or fully circumferential to said bottle B.

The component 20 on the bottle B engages with arc shaped structures 21 & 22 which form part of the structure of the receptacle A. The arc shaped structures 21 have a front side and a side section. Both the arc shaped structures 21 and the side sections 22 are arranged in parallel to each other, both being generally parallel to the horizontal plane, both thereby forming a circumferential horizontal gap. The component 20 on the bottle B is in the form of a protrusion which could be in part or fully circumferential to the bottle B. The gap between the two parallel arc shaped structures 21 being small enough such that when the bottle B is inserted into the receptacle A, the component 20 snugly fits between the two parallel arc shaped structures 21 and the two side structures 22 on the receptacle A as the user rotates the bottle into the receptacle A in an anti-clockwise direction 16 about its axis 17 thereby enabling a firm releasable engagement between the bottle B and the two parallel structures 21 & 22 to be formed. Once inserted, the base of the bottle 10 aligns beneath the upper support plat 7 of the receptacle providing stability, the top section of the back of the bottle being in contact with the inside back plate 5 of the receptacle A. The engagement could preferably enable the dispensing end, as defined in FIG. 2 as the section between the shoulders 12 and the lid 15, of the bottle to face downwards.

So in this example, a circumferential section of the body of the receptacle, not a separate component built into its structure, engages with a component on the bottle, a part or full circumferential protrusion.

Referring to FIG. 6, the second component on the receptacle comprises an arc shaped structures 24 on one side of the receptacle A, and a side sections 25 on the other side of the receptacle A. The arc shaped structure 24 has a front side and a side section. The bottle B features a first component consisting of a pre-moulded indent section 23 which could be partially or fully circumferential to the bottle B and be of any width.

The sides of the receptacle 24 & 25, which are of a width such that they can slot into and engage with a section of the indent first component 23 of the bottle B when the bottle B is inserted into the receptacle B so as to form firm releasable engagement between the bottle B and the receptacle A. Said engagement will preferably enable the dispensing end of the bottle to face downwards.

So in this example, a circumferential section of the body of the receptacle, not a separate component built into its structure, engages with a component on the bottle, a part or full circumferential indent.

It is envisaged that a user would purchase bottles of shampoo, conditioner or gel etc. and one or more support systems. The container could first be used with the first support system in one environment and later transferred to a second support system in another environment, or vice versa. Alternatively the container could first be used with the first support system in one environment, and then removed from that support system and moved to an area where it will stand on its own on its surface contact means. The components of the bottle system having the container, support system, and the engagement means, could be purchased in combination or singly.

Additionally the support system could be self-assembly such that the pad with the connection strip is separate to the receptacle. The user would fix the connection strip and pad to the receptacle prior to fixing the assembled support system to the support structure.

Additionally either the first component or the second component could be in some form of retro fit to the bottle and the receptacle respectively.

Further modifications will be apparent to those skilled in the art without departing from the scope of the present invention.

1. A support system and dispensing container assembly for gels or liquids comprising:
a) a dispensing container for gels or liquids, being fully sealed and self contained, which can be connected to and released from a receiving device of the support system, the dispensing container featuring a dispensing aperture at one first end to enable gel or liquid to be dispensed, and wherein the body of the dispensing container has a body which includes at least one engagement component,
b) a support system comprising:
an adhesion device that adheres to a support structure,
a receiving device configured to releasably engage the dispensing container,
a moveable connection strip with first and second ends which attaches to the adhesion device at one of its ends and to the receiving device at the other end,
wherein the receiving device comprises a back plate which bears at least one engagement component which correspond to the at least one engagement component upon the dispensing container body.

2. A support system and dispensing container assembly according to claim 1 in which the at least one engagement component of the receiving device is located directly upon a planar surface of the back plate.

3. A support system and dispensing container assembly according to claim 1 in which the at least one engagement component of the receiving device is located upon at least one side structure of the back plate.

4. A support system and dispensing container assembly according to claim 1 whereby both the body of the dispensing container and the receiving device each play host to separate corresponding engagement components of an engagement mechanism which cooperate in order to form a firm connection to releasably hold the dispensing container after the dispensing container has been engaged with the receiving device.

5. A support system and dispensing container assembly according to claim 1 wherein the receiving device features an opening which is non parallel to its circumferential structure and runs the full width of the receiving device through which a section of the body of a dispensing container can be inserted.

6. A support system and dispensing container assembly according to claim 1 wherein the body of the dispensing container can be inserted into the receiving device sideways on.

7. A support system and dispensing container assembly according to any claim 1 whereby the receiving device features at least one side section to support the dispensing container.

8. A support system and dispensing container assembly according to any claim 1 whereby at least one of the side sections of the receiving device features a front section to support the dispensing container.

9. A support system and dispensing container assembly according to claim 7&8 whereby the inside of at least the front or side sections of the receiving device features some form of gripping means.

10. A support system and dispensing container assembly according to claim 1 wherein the first end of the dispensing container faces downwards after insertion of the dispensing container into the receiving device.

11. A support system and dispensing container assembly according to claims 4-10 featuring an engagement mechanism that comprises a first engagement component located away from the first end and towards the second end of the dispensing container which releasibly interlocks with a second engagement component on the receiving device.

12. A support system and dispensing container assembly according to claims 4-11 featuring an engagement mechanism comprised of two components, wherein at least one of the engagement components to be found on either the dispensing container or the receiving device is at least in part a raised structure which engages with a second engagement component which is at least in part an indented structure, the second component being located on the respective receiving device or dispensing container to which the receiving device or dispensing container engages in order to form a firm, releasable connection,

13. A support system and dispensing container assembly according to claims 4-12 featuring an engagement mechanism comprising a first engagement component on the dispensing container which inserts into the second engagement component on the receiving device.

14. A support system and dispensing container assembly according to claims 4-13 featuring a receiving device with a second engagement component selected from a group comprising a ridge or ridges, a notch or notches or other indented structure which engages with a first engagement component selected from a group comprising pips, protrusion or other raised structure on the dispensing container to form a firm, releasable connection.

15. A support system and dispensing container assembly according to any of claims 4-12 featuring an engagement mechanism comprising a second engagement component on the receiving device which inserts into the first engagement component on the dispensing container.

16. A support system and dispensing container assembly according to any of claims 4-12 featuring an engagement mechanism comprising a first engagement component on the receiving device which inserts into the second engagement component on the dispensing container.

17. A support system and dispensing container assembly according to any of claims 4-16 wherein the second engagement component is located on the inside circumference of the receiving device.

18. A support system and dispensing container assembly according to claim 1 wherein the receiving device is essentially a single piece structure.

19. A method of using the support system and dispensing container assembly of claims 1-18 wherein engagement of the dispensing container with the receiving device and subsequent release of the dispensing container from the receiving device is performed by holding and manipulating the dispensing container relative to the receiving device.

20. A method of using the support system and dispensing container assembly of claims 1-19 wherein the engagement mechanism between the receiving device and the dispensing container is consummated by securely holding the receiving device with one hand and then rotating the dispensing container in a first direction relative to the receiving device wherein a firm releasable engagement is formed between the receiving device and the dispensing container.

21. A method of using the support system and dispensing container assembly of claims 1-20 wherein the engagement mechanism between the receiving device and the dispensing container is released by securely holding the receiving device with one hand and then rotating the dispensing container relative to the receiving device in a direction opposite to the first direction to a second position wherein the dispensing container and the receiving device are fully unlocked from each other and the container is fully released from the receiving device.

22. A method of using the support system and dispensing container assembly of claims 1-21 wherein the engagement mechanism between the first and second components is consummated by securely holding the receiving device with one hand and then rotating the dispensing container in a first direction relative to the receiving device featuring the second component to a first position wherein the first and second components are fully interlocked with each other and the container cannot rotate any further in the first direction.

23. A method of using the support system and dispensing container assembly of claims 1-22 wherein the engagement mechanism between the first and second components is released by rotating the dispensing container relative to the receiving device in a direction opposite to the first direction to a second position wherein the first and second components are fully unlocked from each other and the container is fully released from the receiving device

24. A method of using the support system and dispensing container assembly of claims 1-23 whereby at least engagement or disengagement between the dispensing container and the receiving device can be consummated with a single rotating action.

25. A support system and dispensing container assembly according to claim 1 featuring a dispensing container which has a surface contact means at the first end of the dispensing container opposing the second end allowing the dispensing container to freely stand on a surface on the surface contact means.

26. A support system and dispensing container assembly according to claim 1 featuring a dispensing container with a surface contact means at a second end of the dispensing container opposing the first end allowing the dispensing container to stand on a surface on the surface contact means.

27. A support system and dispensing container assembly according to claim 1 wherein the engagement mechanism predetermines the orientation of the dispensing container relative to the support system.

28. A support system and dispensing container assembly according to claim 1 wherein the dispensing container is squeeze-to-use.

29. A support system and dispensing container assembly according to claim 1 wherein when the dispensing container is in a vertical position being engaged within the receiving device prior to use, the dispensing container lies in contact with the vertical support structure.

30. A support system and dispensing container assembly according to claim 1 wherein the support system attaches to the support structure in a manner which is non-invasive to the support structure comprising a method selected from the group consisting chemical adhesive surface, suction pads, suction cups, bio-mimicry technology or other non-invasive method.

31. A support system and dispensing container assembly according to claim 1 whereby the receiving device features an upper support plate.

32. A support system and dispensing container assembly according to claim 1 whereby the connection strip is made from a flexible material.

33. A support system and dispensing container assembly according to claim 1 whereby the second engagement component features ends which are arrowhead or any other bulbous shape to provide extra resistance to dispensing container extraction from the receiving device.

34. A support system and dispensing container assembly according to claim 1 whereby when the dispensing container is in a vertical position being engaged within the receiving device prior to use, the dispensing container lies almost essentially flat against the vertical support structure.

35. A support system and dispensing container assembly according to claim 1 whereby the pre-moulded indent or indents are located on any section or sections between the shoulders and the base of the dispensing container which does not spoil the visual equity of the dispensing container, its frontal appearance.

36. A support system and dispensing container assembly according to claim 1 whereby the engagement component or components on the dispensing container are pre-moulded.

37. A support system and dispensing container assembly according to claim 1 whereby the external back plate is in contact with the vertical support structure.
